(19) United States
(12) Patent Application Publication
(10) Pub. No.: US 2023/0239709 A1
(43) Pub. Date: Jul. 27, 2023

(54) WIRELESS CONTROL METHOD, WIRELESS CONTROL DEVICE AND WIRELESS CONTROL SYSTEM

(71) Applicant: NIPPON TELEGRAPH AND TELEPHONE CORPORATION, Tokyo (JP)

(72) Inventors: Shinya OTSUKI, Musashino-shi, Tokyo (JP); Junichi IWATANI, Musashino-shi, Tokyo (JP); Hiroshi SAKAMOTO, Musashino-shi, Tokyo (JP); Masayoshi NABESHIMA, Musashino-shi, Tokyo (JP); Tomoaki OGAWA, Musashino-shi, Tokyo (JP)

(73) Assignee: NIPPON TELEGRAPH AND TELEPHONE CORPORATION, Tokyo (JP)

(21) Appl. No.: 17/928,241

(22) PCT Filed: Jun. 1, 2020
(86) PCT No.: PCT/JP2020/021656

§ 371 Date: Nov. 28, 2022

(51) Int. Cl. H04W 24/02; H04W 72/541; H04W 4/029; H04B 17/318

(52) U.S. Cl. CPC H04W 24/02; H04B 17/318; H04W 4/029; H04W 72/541

(57) ABSTRACT

There are provided a first wireless system, a second wireless system, an information collection terminal, and a wireless control apparatus. The first wireless system includes a fixed wireless access apparatus that performs communication with a movable wireless terminal. The second wireless system performs communication in a limited communication area using a frequency band that is the same as or overlaps a frequency band of the first wireless system. The information collection terminal is installed in the communication area of the second wireless system and collects information on the wireless communication of the first wireless system. The wireless control apparatus controls the communication of the first wireless system. The wireless control apparatus controls the communication of the first wireless system when approach of the wireless terminal to the communication area of the second wireless system is detected, based on information on the wireless communication collected by the information collection terminal. This can prevent the first wireless system from causing harmful interference with the second wireless system.

### TECHNICAL FIELD

The present disclosure relates to a technology for avoiding harmful interference when a plurality of different types of wireless systems use the same or overlapping frequency band.

### BACKGROUND ART

In a plurality of different types of wireless systems that use the same or overlapping frequency band, it is necessary to avoid harmful interference between the wireless systems. Examples of a conceivable method of avoiding harmful interference between wireless systems include a method of setting a use exclusion zone using a geographical database (for example, see NPL 1), and a method of setting an upper limit on the number of used wireless systems (for example, see NPL 2).

### CITATION LIST

### Non Patent Literature

[NPL 1] Unlicensed Use of the 6 GHz Band (https://docs.fcc.gov/public/attachments/DOC-354364Al.pdf)
[NPL 2] Outdoor use of wireless LAN (https://www.tele.soumu.go.jp/j/sys/others/wlan_outdoor/index.htm)

### SUMMARY OF THE INVENTION

### Technical Problem

For example, when one of two different types of wireless systems is a wireless local area network (LAN) and the other is a fixed wireless communication with a very sharp antenna directivity, a problem arises that the wireless LAN causes harmful interference with the fixed wireless communication.

In the above case, because an installation position of a wireless access apparatus (Access Point (AP)) of the wireless LAN is fixed, the AP is installed outside a use exclusion zone for the fixed wireless communication using a geographical database, so that harmful interference does not occur. However, when a movable wireless terminal (STAtion (STA)) of the wireless LAN enters the use exclusion zone, harmful interference with the fixed wireless communication occurs.

Further, in the case of satellite communication a communication range of which overlaps that of a wireless LAN, since an amount of interference is proportional to the number of STAs in the wireless LAN, a method of setting an upper limit on the number of used STAs is effective in avoiding interference. However, in the case of fixed wireless communication with a very sharp antenna directivity, a problem arises that harmful interference occurs even when a single STA of the wireless LAN enters a main beam of an antenna.

An object of the present disclosure is to provide a wireless control method, a wireless control apparatus, and a wireless control system capable of avoiding harmful interference due to entrance of a wireless terminal of one wireless system into a communication area of another wireless system when a plurality of different types of wireless systems use the same or overlapping frequency band.

### Means for Solving the Problem

The present disclosure is a wireless control method including: a first wireless system including a fixed wireless access apparatus that performs communication with at least one movable wireless terminal; a second wireless system that performs communication in a limited communication area using a frequency band that is the same as or overlaps a frequency band of the first wireless system; one or more information collection terminals that collect information on the wireless communication of the first wireless system, at least one of the one or more information collection terminals being installed in the communication area of the second wireless system; and a wireless control apparatus that controls the communication of the first wireless system, wherein the wireless control apparatus controls the communication of the first wireless system such that communication of the wireless terminal does not cause harmful interference with the communication of the second wireless system, when approach of the wireless terminal to the communication area of the second wireless system is detected, based on information on the first wireless system and the second wireless system, and the information on the wireless communication collected by the one or more information collection terminals.

Further, the present disclosure is a wireless control apparatus for controlling communication of a first wireless system of a system, the system including the first wireless system including a fixed wireless access apparatus that performs communication with at least one movable wireless terminal, a second wireless system that performs communication in a limited communication area using a frequency band that is the same as or overlaps a frequency band of the first wireless system, and one or more information collection terminals that collect information on the wireless communication of the first wireless system, at least one of the one or more information collection terminals being installed in the communication area of the second wireless system, the wireless control apparatus including: a database that stores information on the first wireless system and the second wireless system, and the information on the wireless communication collected by the one or more information collection terminals; an information collection server that determines, based on the information stored in the database and information on a transmission power of the wireless terminal notified from the wireless access apparatus of the first wireless system, a threshold value of a reception power of a wireless signal at each information collection terminal, the wireless signal being transmitted by the wireless terminal, detect approach of the wireless terminal to the communication area when the reception power of the wireless terminal collected by each information collection terminal is equal to or higher than the threshold value, and transmit a request for stopping the wireless terminal; and a control server that determines a parameter of the wireless access apparatus based on the information stored in the database and transmit the request for stopping the wireless terminal received from the information collection server to the wireless access apparatus.

Further, the present disclosure is a wireless control system including: a first wireless system including a fixed wireless access apparatus that performs communication with at least one movable wireless terminal; a second wireless system that performs communication in a limited communication area using a frequency band that is the same as or overlaps a frequency band of the first wireless system; one or more information collection terminals configured to collect information on the wireless communication of the first wireless system, at least one of the one or more information collection terminals being installed in the communication area of the second wireless system; and a wireless control apparatus that controls the communication of the first wireless system, wherein the wireless control apparatus controls the communication of the first wireless system such that communication of the wireless terminal does not cause harmful interference with the communication of the second wireless system, when approach of the wireless terminal to the communication area of the second wireless system is detected, based on information on the first wireless system and the second wireless system, and the information on the wireless communication collected by the one or more information collection terminals.

### Effects of the Invention

The wireless control method, the wireless control apparatus, and the wireless control system according to the present disclosure provide a wireless control method, a wireless control apparatus, and a wireless control system capable of avoiding harmful interference due to entrance of a wireless terminal of one wireless system into a communication area of another wireless system when a plurality of different types of wireless systems use the same or overlapping frequency band.

### BRIEF DESCRIPTION OF DRAWINGS

FIG. 1 is a diagram illustrating an example of a wireless control system according to a first embodiment.

FIG. 2 is a diagram illustrating an example of a FS-DB.

FIG. 3 is a diagram illustrating an example of an AP-DB.

FIG. 4 is a diagram illustrating an example of a wireless environment DB.

FIG. 5 is a diagram illustrating an example of an operation sequence (⅓).

FIG. 6 is a diagram illustrating an example of an operation sequence (⅔).

FIG. 7 is a diagram illustrating an example of an operation sequence (3/3).

FIG. 8 is a diagram illustrating an application example of the wireless control system.

FIG. 9 is a diagram illustrating an application example of the operation sequence.

### DESCRIPTION OF EMBODIMENTS

Hereinafter, embodiments of a wireless control method, a wireless control apparatus, and a wireless control system according to the present disclosure will be described with reference to the drawings.

Here, in the following embodiments, two different types of wireless systems that use the same or overlapping frequency band are referred to as a first wireless system and a second wireless system. The first wireless system is a wireless system in which a fixedly installed wireless access apparatus and a movable wireless terminal communicate with each other in a wide communication area using an omnidirectional or broad directional antenna. The second wireless system is a wireless system in which communication is performed between fixedly installed wireless apparatuses in a limited communication area using an antenna with sharp directivity. For example, the first wireless system corresponds to a wireless LAN system conforming to IEEE 802.11ax and the second wireless system corresponds to a fixed wireless system having very sharp antenna directivity.

The wireless LAN system of the first wireless system is an interfering wireless system that interferes with the fixed wireless system of the second wireless system. On the other hand, the fixed wireless system of the second wireless system is an interference-receiving wireless system that receives interference from the wireless LAN system of the first wireless system.

In the following embodiments, a case in which the first wireless system is the wireless LAN system and the second wireless system is the fixed wireless system will be described, but each embodiment can be similarly applied to similar wireless systems.

### First Embodiment

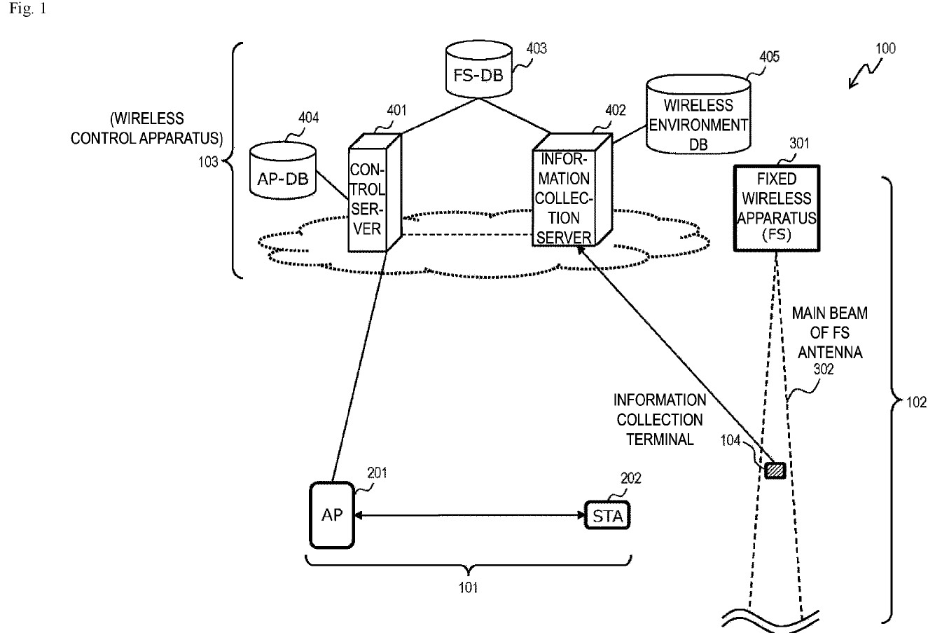

FIG. 1 illustrates an example of a wireless control system 100 according to a first embodiment. In FIG. 1, the wireless control system 100 includes a wireless LAN system 101, a fixed wireless system 102, a wireless control apparatus 103, and an information collection terminal 104.

In the example of FIG. 1, the wireless LAN system 101 and the fixed wireless system 102 use the same or overlapping frequency band. The wireless control apparatus 103 controls the wireless LAN system 101 so that harmful interference with the fixed wireless system 102 is avoided, based on, for example, information collected by the information collection terminal 104.

The wireless LAN system 101 includes a wireless access apparatus (AP) 201 such as an access point, and a wireless terminal (STA) 202. Here, the AP 201 is fixedly installed in a predetermined place, and the STA 202 is a movable wireless terminal such as a smartphone that performs wireless communication with the AP 201.

The fixed wireless system 102 includes a fixed wireless apparatus (FS) 301 and performs communication in a limited communication area with a similar fixed wireless apparatus (not illustrated) facing the FS 301. For example, in FIG. 1, the FS 301 performs communication with the similar wireless apparatus facing the FS 301 in a communication area limited to a main beam 302 having very sharp antenna directivity. Here, because the antenna directivity is sharp, harmful interference occurs when another wireless apparatus using the same or overlapping frequency band enters the main beam 302, but an influence is small when the wireless apparatus is far from the main beam 302. Thus, it is necessary to prevent other wireless apparatuses using the same or overlapping frequency band from entering the main beam 302.

The wireless control apparatus 103 prevents the STA 202 of the wireless LAN system 101 from entering the main beam 302 of the fixed wireless system 102 and causes harmful interference with the communication of the FS 301, based on information regarding wireless communication collected by the information collection terminal 104. A detailed configuration of the wireless control apparatus 103 will be described below.

The information collection terminal 104 monitors wireless communication between the AP 201 and the STA 202 of the wireless LAN system 101, and notifies the information collection server 402 of the information on the monitored wireless communication. In the example of FIG. 1, one information collection terminal 104 is installed in the main beam 302 of the FS 301, but a plurality of the information collection terminals 104 may be installed, as in an application example to be described below. Here, an installation position of the information collection terminal 104 is determined in advance, and the installation position is stored in the wireless control apparatus 103.

Thus, the wireless control system 100 according to the present embodiment can prevent the STA 202 of the wireless LAN system 101 from causing harmful interference with the fixed wireless system 102, by using the information collection terminal 104.

### Configuration Example of Wireless Control Apparatus 103

In FIG. 1, the wireless control apparatus 103 includes a control server 401, an information collection server 402, a fixed wireless database (FS-DB) 403, an access point database (AP-DB) 404, and a wireless environment DB 405.

The control server 401 controls the AP 201 based on information on the FS-DB 403 and AP-DB 404. The FS-DB 403 is a database that holds information on the fixed wireless system 102. The AP-DB 404 is a database that holds information on the AP 201 and the STA 202 of the wireless LAN system 101. The control server 401 notifies the below-described information collection server 402 of the information on the STA 202 via a network such as a cloud, and transfers a request for stopping the STA 202 received from the information collection server 402 to the AP 201.

The information collection server 402 records the information on wireless communication acquired from the at least one information collection terminal 104 in the wireless environment database (wireless environment DB) 405. Details of the wireless environment DB 405 will be described below. Here, the information on wireless communication is, for example, information such as a frequency or reception power of the wireless communication between the STA 202 and the AP 201. The information collection server 402 detects the approach of the STA 202 to the main beam 302 based on the information on the wireless communication acquired from the information collection terminal 104 and the information on the fixed wireless system 102 held in the FS-DB 403. When the information collection server 402 detects the approach of the STA 202 to the main beam 302, the information collection server 402 transmits, to the control server 401, a stop request for stopping the transmission of the STA 202. The stop request is transferred from the control server 401 to the AP 201 and transmitted from the AP 201 to the STA 202. The STA 202 that has received the stop request from the AP 201 stops the transmission.

Thus, the wireless control apparatus 103 according to the present embodiment detects the approach of the STA 202 to the main beam 302, and stops the transmission of the STA 202 of the wireless LAN system 101 when the STA 202 is approaching the main beam 302. This can prevent the STA 202 of the wireless LAN system 101 using a frequency band that is the same as or overlaps that of the fixed wireless system 102 from causing harmful interference with the communication of the fixed wireless system 102.

Here, in the example of FIG. 1, the wireless control apparatus 103 includes five elements of the control server 401, the information collection server 402, the FS-DB 403, the AP-DB 404, and the wireless environment DB 405. However, the number of elements included in the wireless control apparatus 103 does not need to be five. For example, the control server 401 and the information collection server 402 may be integrated into one server, or the FS-DB 403, the AP-DB 404, and the wireless environment DB 405 may be integrated into one database. Further, the database may be included in the wireless control apparatus 103.

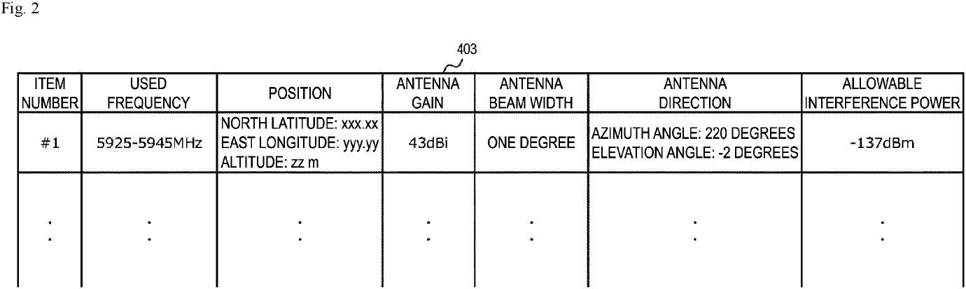

FIG. 2 illustrates an example of the FS-DB 403. Information on the FS 301 of the fixed wireless system 102 is held in the FS-DB 403 in advance. A used frequency, installation position, antenna gain, antenna beam width, antenna direction, and allowable interference power are stored as information on the FS 301 in the FS-DB 403. In the example of FIG. 2, the used frequency is 5925 - 5945 MHz, the north latitude of the installation position is xxx.xx, the east longitude of the installation position is yyy.yy, the altitude of the installation position is zz m, the antenna gain is 43 dBi, the antenna beam width is 1 degree, the azimuth angle of the antenna direction is 220 degrees, the elevation angle of the antenna direction -2 degrees, and the allowable interference power is -137 dBm. When there are a plurality of the FSs 301, item numbers such as #1, #2, ..., are assigned, and FIG. 2 illustrates an example of the FS 301 having the item number # 1.

Thus, the information on the FS 301 of the fixed wireless system 102 is stored in the FS-DB 403. Here, because a position of the FS 301 or information on the antenna are stored in the FS-DB 403, a geographical position or range of the main beam 302 (communication area) can be understood.

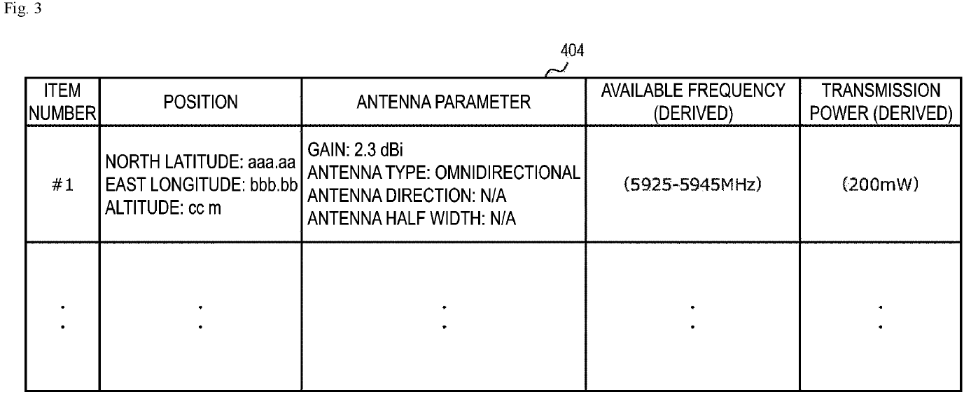

FIG. 3 illustrates an example of the AP-DB 404. In the AP-DB 404, information on the AP 201 of the wireless LAN system 101 is stored in advance, and information derived by the control server 401 based on the information on the FS-DB 403 is stored. For example, system information such as an installation position or antenna parameters, and derived information such as an available frequency or transmission power according to a wireless environment are stored as information on the AP 201 in the AP-DB 404. In the example of FIG. 3, the installation position in which the north latitude is aaa.aa, the east longitude is bbb.bb, and the altitude is cc m, the antenna parameters in which the gain is 2.3 dBi, the antenna type is omnidirectional, the antenna direction is N/A (Not Applicable), and the antenna half width is N/A, the available frequency, and the transmission power are stored. When there are a plurality of the APs 201, the item numbers such as #1, #2, ..., are assigned, and FIG. 3 illustrates an example of the AP 201 having the item number #1.

Here, the available frequency and the transmission power are a frequency and a transmission power of a wireless signal that is used by the AP 201. The AP 201 requests available parameters from the control server 401. The control server 401 refers to the FS-DB 403 and determines a frequency and a transmission power available to the AP 201 based on a wireless frequency used by the FS 301, a distance between the AP 201 and the FS 301, a width or direction of the main beam 302, and the like. When the frequency available to the AP 201 is the same as or overlaps a frequency band of the FS 301, the transmission power is determined so that harmful interference does not occur in the main beam 302. In the example of FIG. 3, derived values such as an available frequency of 5925 - 5945 MHz and a transmission power of 200 mW (23 dBm) are stored in the AP-DB 404. Here, communication between the STA 202 and the AP 201 is performed by time division multiplexing at the same frequency.

Thus, the information on the AP 201 of the wireless LAN system 101 is stored in the AP-DB 404.

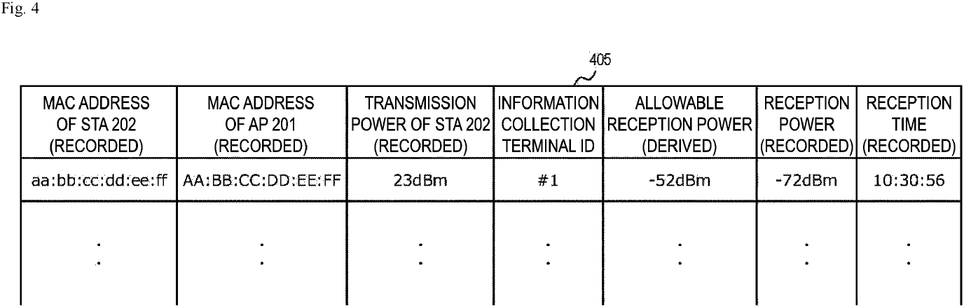

FIG. 4 illustrates an example of the wireless environment DB 405. Information regarding wireless communication that the information collection server 402 has collected using the information collection terminal 104 is recorded on the wireless environment DB 405, and information notified from the control server 401, information derived by the information collection server 402, and the like are stored in the wireless environment DB 405. For example, a media access control (MAC) address of the STA 202, an MAC address of the AP 201, the transmission power of the STA 202, an ID of the information collection terminal 104, an allowable reception power, a reception power, and a reception time are stored in the wireless environment DB 405.

In the example of FIG. 4, the MAC address of STA 202 is aa:bb:cc:dd:ee:ff, the MAC address of the AP 201 is AA:BB:CC:DD:EE:FF, the transmission power of the STA 202 is 23 dBm, the ID of the information collection terminal 104 is #1, the allowable reception power is -52 dBm, the reception power is -72 dBm, and the reception time is 10:30:56. FIG. 4 illustrates a case in which the one information collection terminal 104 is present, but when there are a plurality of the information collection terminals 104, information on IDs of the information collection terminals 104 such as #2 and #3 is recorded on the wireless environment DB 405. It is assumed that the information collection terminal 104 is installed at a predetermined position, and the position of the information collection terminal 104 is stored in the information collection server 402 in advance.

Here, information such as the MAC address of the STA 202, the MAC address of the AP 201, and the transmission power of the STA 202 is information notified from the control server 401 to the information collection server 402. The ID of the information collection terminal 104 is acquired from the information collection terminal 104, and the allowable reception power is derived based on the allowable interference power of the FS 301 and an attenuation of free space propagation according to a distance from the FS 301 to the information collection terminal 104. For example, when the allowable interference power of the FS 301 is -137 dBm and a free space propagation loss between the FS 301 and the information collection terminal 104 is 85 dB, the allowable reception power at the position of the information collection terminal 104 is -52 dBm.

Further, a reception power and a reception time of a wireless signal of the STA 202 actually monitored by the information collection terminal 104 are recorded on the wireless environment DB 405.

Thus, the information on wireless communication collected by the information collection terminal 104 is recorded on the wireless environment DB 405, and information notified from the control server 401, information derived by the information collection server 402, and the like are recorded on the wireless environment DB 405.

Here, in FIGS. 2, 3 and 4, an item described as (recorded) means notified data, an item described as (derived) means data calculated based on other information, and other items are preset data.

### Operation Sequence

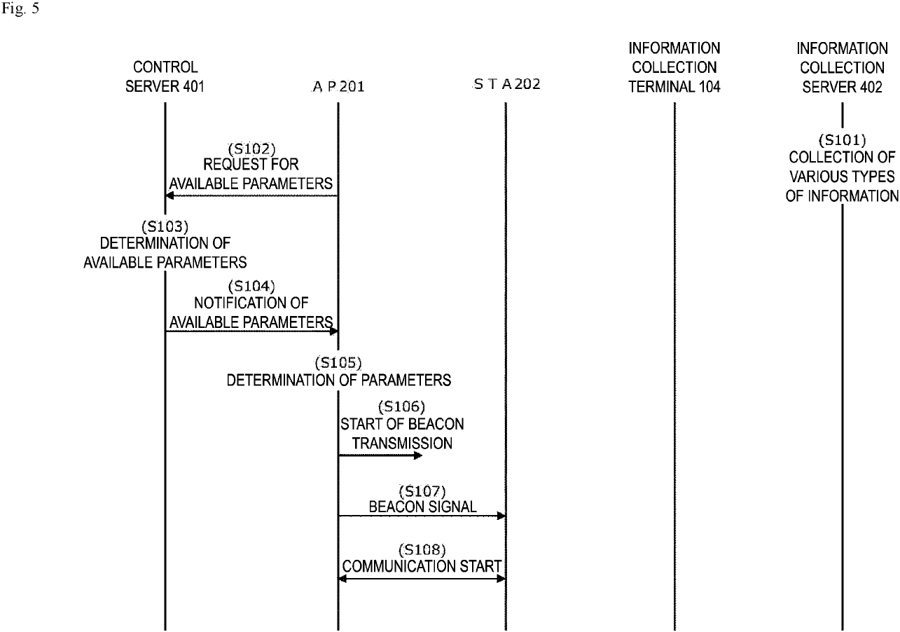

FIGS. 5, 6 and 7 illustrate examples of operation sequences of the wireless control system 100 according to the present embodiment. The operation sequences illustrated in FIGS. 5, 6 and 7 are executed by the control server 401, the information collection server 402, the information collection terminal 104, the AP 201, and the STA 202 constituting the wireless control system 100 described with reference to FIG. 1. It is assumed that the information collection terminal 104 is installed at a predetermined position in the main beam 302 of the FS 301.

Here, a series of operation sequences executed by the wireless control system 100 are described separately in three diagrams of FIGS. 5, 6 and 7.

First, the operation sequence illustrated in FIG. 5 will be described in order.

In step S101, the information collection server 402 collects various types of information on the FS 301 from the FS-DB 403 described with reference to FIG. 2.

In step S102, the AP 201 of the wireless LAN system 101 requests available parameters from the control server 401 before a signal is transmitted. The available parameters are information necessary for an operation of the AP 201, such as the wireless frequency and the transmission power.

In step S103, the control server 401 searches the AP-DB 404 for parameters regarding the AP 201 that has requested the available parameters. Here, the control server 401 determines parameters that the AP 201 can use without causing harmful interference with the communication of the FS 301, based on the parameters regarding the AP 201 and parameters of the FS 301 obtained from the FS-DB 403. For example, the control server 401 acquires information on the installation position and the antenna parameters of the AP 201 from the AP-DB 404, and acquires information on the installation position, the antenna parameters, and the allowable interference power of the FS 301 from the FS-DB 403. The control server 401 determines the parameters of the AP 201 so that a wireless signal transmitted from the AP 201 installed at a fixed position does not cause harmful interference with the communication of the FS 301, based on the acquired information. This can prevent the wireless signal transmitted by the AP 201 from causing harmful interference with the communication of the FS 301. Thus, in the case of the AP 201 installed at a fixed position, it is easy to avoid harmful interference with the FS 301, but in the case of the moving STA 202, processing to be described below is required.

In step S104, the control server 401 notifies the AP 201 of at least one parameter determined in step S103.

In step S105, the AP 201 determines parameters to be actually used from the at least one available parameter notified from the control server 401 in step S104. When a plurality of the available parameters are notified from the control server 401, one parameter is selected from the plurality of available parameters using a predetermined method and set in the AP 201.

In step S106, the AP 201 starts transmission of a beacon signal using the parameters determined in step S105.

In step S107, the AP 201 transmits the beacon signal in a predetermined cycle, and notifies wireless terminals around the AP 201 of the presence of the AP 201. In the example of FIG. 5, the beacon signal transmitted from the AP 201 is received by the STA 202. Here, the beacon signal includes information such as an identifier of the AP 201 or available frequency channels, as information necessary for connection to the AP 201.

In step S108, the STA 202 connects to the AP 201 based on the beacon signal received from the AP 201 and starts communication with the AP 201. In this case, the STA 202 notifies the AP 201 of information such as the MAC address and the transmission power.

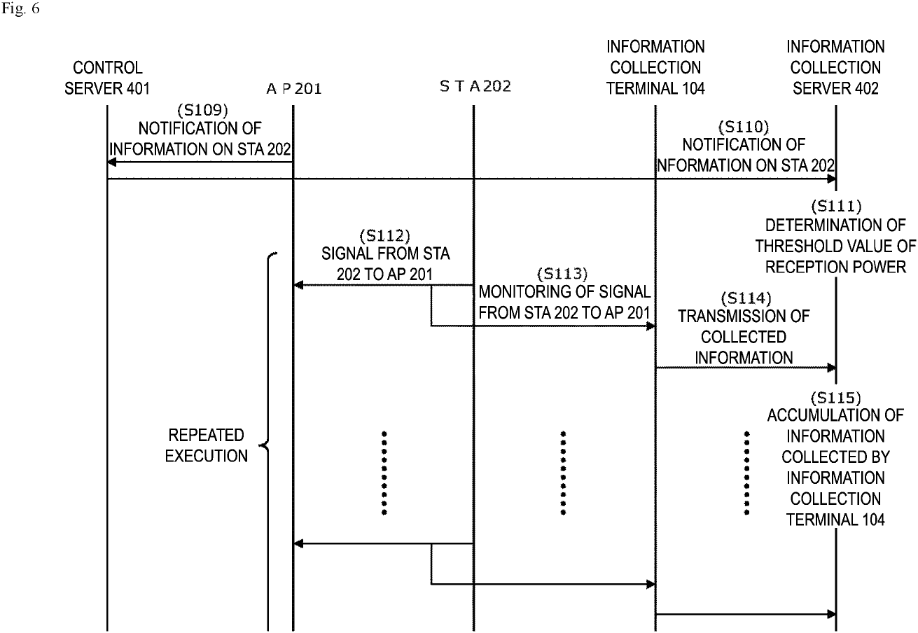

FIG. 6 illustrates an operation sequence following step S108 of FIG. 5.

In step S109, the AP 201 notifies the control server 401 of the information such as the transmission power acquired from STA 202. In step S110, the control server 401 notifies the information collection server 402 of the information on the STA 202 notified from the AP 201.

In step S111, the information collection server 402 derives a threshold value of the reception power at the information collection terminal 104 from the information (such as the transmission power) regarding the STA 202 notified in step S110. Specifically, when the information collection terminal 104 is in the main beam 302 of the FS 301, the information collection server 402 derives a threshold value of the reception power used for detecting that the STA 202 is approaching a communication area obtained by adding a margin to a width of the main beam 302. For example, the reception power of the STA 202 at the information collection terminal 104 when the STA 202 approaches the communication area including the margin is calculated from the transmission power of the STA 202 in consideration of the attenuation of the free space propagation. The information collection server 402 sets the calculated reception power as a threshold value. A margin (for example, -5%) may be set as the threshold value.

In step S112, the STA 202 sends a signal to the AP 201 to communicate with the AP 201.

In step S113, the information collection terminal 104 monitors the signal transmitted from the STA 202 to the AP 201.

In step S114, the information collection terminal 104 transmits information (such as reception power and reception time) collected from the monitored signal to the information collection server 402.

In step S115, the information collection server 402 stores the information collected by the information collection terminal 104 in the wireless environment DB 405.

Here, in the wireless control system 100, the operation from step S112 to step S115 is repeatedly executed until the reception power collected from the information collection terminal 104 becomes equal to or higher than the threshold value set in step S111 (Relationship (1)).

$$\text{Reception power} \geq \text{threshold value}$$

The fact that the reception power of the STA 202 in the information collection terminal 104 is equal to or higher than the threshold value means that the STA 202 is approaching the communication area.

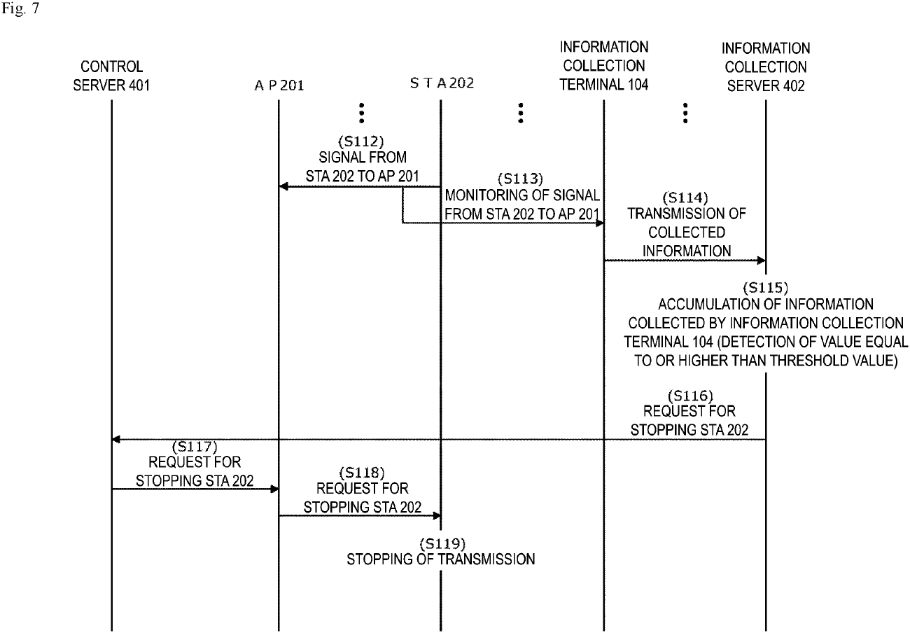

FIG. 7 illustrates an operation sequence when the reception power collected from the information collection terminal 104 becomes equal to or higher than the threshold value during the repeated operation from step S 112 to step S 115 of FIG. 6.

In step S116, when the information collection server 402 detects that the reception power collected from the information collection terminal 104 is equal to or higher than the threshold value, the information collection server 402 transmits a stop request for stopping the transmission of the STA 202 to the control server 401.

In step S117, the control server 401 transfers, to the AP 201, the stop request for stopping the STA 202 received from the information collection server 402.

In step S118, the AP 201 transmits the stop request to the STA 202.

In step S119, the STA 202 receives the stop request from the AP 201 and stops the transmission of the wireless signal to the AP 201.

The STA 202 that has stopped the transmission of the wireless signal to the AP 201 may perform processing of, for example, connecting to another AP.

Further, when the STA 202 cannot stop the transmission of the wireless signal to the AP 201, the control server 401 may request the AP 201 to change the used frequency, so that the frequency of the wireless signal that the STA 202 transmits to the AP 201 is changed. In this case, the frequency is changed to a frequency different from that of the FS 301.

Thus, the wireless control system 100 according to the present embodiment can detect the approach of the STA 202 to the communication area of the fixed wireless system 102 and stop the transmission of the STA 202 before the STA 202 enters the communication area. This prevents the STA 202 of the wireless LAN system 101 from causing harmful interference with the fixed wireless system 102.

Here, FIGS. 5 to 7 illustrate examples of operation sequences corresponding to a configuration in which the one information collection terminal 104 is present in the main beam 302 of the FS 301 (the wireless control system 100 in FIG. 1). In an application example to be described below, a case in which a plurality of the information collection terminals 104 are installed will be described.

### Application Example

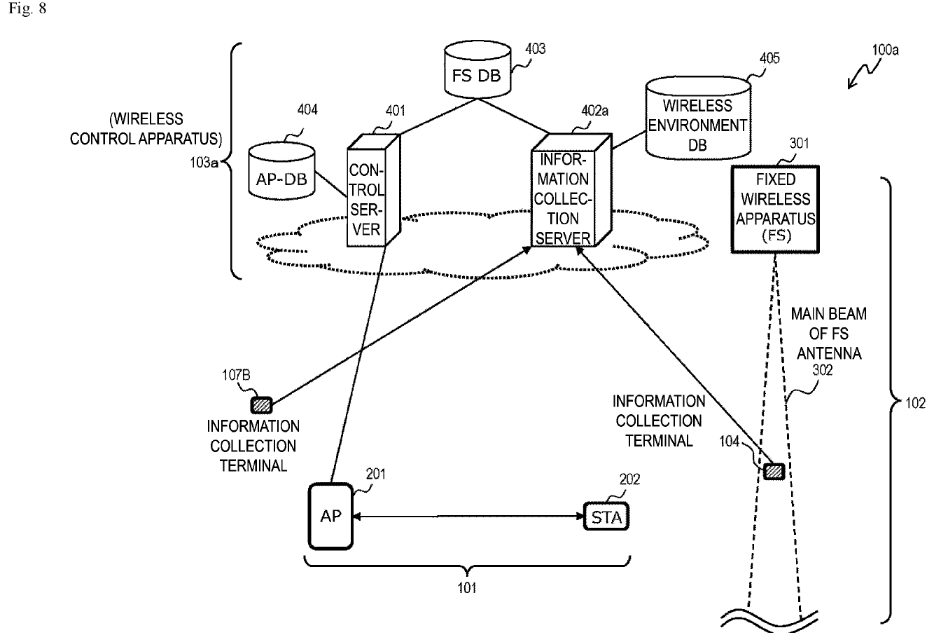

FIG. 8 illustrates a wireless control system 100a as an application example. In FIG. 8, blocks having the same reference signs as those in FIG. 1 operate as in FIG. 1, and the wireless LAN system 101 and the fixed wireless system 102 are the same systems as in the example of FIG. 1. Further, the wireless control apparatus 103a controls the wireless LAN system 101 so that harmful interference between the wireless systems is avoided by using a plurality of the information collection terminals 104. Although, in the example of FIG. 8, two terminals of an information collection terminal 104A and an information collection terminal 104B are described, three or more terminals may be used. Here, the information collection terminal 104A corresponds to a first information collection terminal, and the information collection terminal 104B corresponds to a second information collection terminal.

In FIG. 8, the one information collection terminal 104A is installed in the same main beam 302 as that in the information collection terminal 104 of FIG. 1, and the other one information collection terminal 104B is installed at a position away from the main beam 302. In this application example, because a position of the STA 202 between the information collection terminal 104A and the information collection terminal 104B can be estimated, the STA 202 can be detected with higher accuracy than in the above embodiment. Installation positions of the information collection terminal 104A and the information collection terminal 104B are determined in advance, and are stored in advance in the information collection server 402a.

Further, neither the information collection terminal 104A nor the information collection terminal 104B may be installed in the main beam 302, but it is preferable that the at least one information collection terminal 104A be installed in the main beam 302 of the FS 301, as illustrated in FIG. 8. This makes it possible to reliably detect the STA 202 approaching the main beam 302. Further, when the information collection terminal 104A and the information collection terminal 104B are installed outside the main beam 302, it is preferable that the information collection terminal 104A and the information collection terminal 104B be installed so as to sandwich the main beam 302. Thus, the position of the STA 202 around the main beam 302 can be accurately understood.

Here, the information collection terminal 104A and the information collection terminal 104B monitor the wireless communication between the AP 201 and the STA 202, collect the information on the wireless communication such as the frequency or the reception power of the wireless signal, and notify the information collection server 402a of the information, as in the case of FIG. 1. The information collection server 402a acquires the information from a plurality of terminals including the information collection terminal 104A and the information collection terminal 104B, but basically operates as in the information collection server 402 of FIG. 1.

In FIG. 8, the wireless control apparatus 103a controls the wireless LAN system 101 based on the information on the wireless communication acquired from the information collection terminal 104A and the information collection terminal 104B. For example, with respect to the wireless signal that the STA 202 transmits to the AP 201, the information collection server 402a acquires a reception power A monitored by the information collection terminal 104A and a reception power B monitored by the information collection terminal 104B. Here, the reception power A corresponds to a first reception power, and the reception power B corresponds to a second reception power.

Then, when a difference between the reception power A and the reception power B (reception power A - reception power B) is equal to or higher than a predetermined threshold value, the information collection server 402a can estimate that the STA 202 is closer to the information collection terminal 104A than to the information collection terminal 104B (Relationship (2)).

$$\text{Reception power A - reception power B} \geq \text{threshold value}$$

Here, the difference between the reception power A and the reception power B in Relationship (2) is an index for estimating where the STA 202 is present between the information collection terminal 104A and the information collection terminal 104B. For example, when the difference is 0, it can be estimated that the STA 202 is in the middle between the information collection terminal 104A and the information collection terminal 104B. When the difference is large and positive (reception power A > reception power B), it can be estimated that the STA 202 is closer to the information collection terminal 104A than to the information collection terminal 104B. On the other hand, when the difference is large and negative (reception power A < reception power B), it can be estimated that the STA 202 is closer to the information collection terminal 104B than to the information collection terminal 104A.

Further, a distance from the information collection terminal 104A to the STA 202 can be derived by assuming free space propagation based on the transmission power of the STA 202, and the position and the reception power A of the information collection terminal 104A. Similarly, a distance from the information collection terminal 104B to the STA 202 can be derived by assuming free space propagation based on the transmission power of the STA 202, the position and the reception power B of the information collection terminal 104B. Here, because the positions of the information collection terminal 104A and the information collection terminal 104B are known, the position of the STA 202 is accurately identified based on the distance from the STA 202 to the information collection terminal 104A and the distance from the STA 202 to the information collection terminal 104B. Because a position of the main beam 302 (communication area) is known, it is possible to detect whether or not the STA 202 approaches the main beam 302.

When at least the one information collection terminal 104A is present in the main beam 302, both the detection using Relationship (1) described in the above embodiment and the detection using Relationship (2) of the present application example may be performed.

In FIG. 8, the information collection server 402a detects the approach of the STA 202 to the main beam 302 when Relationship (2) (or both Relationships (1) and (2)) is satisfied, and determines that the STA 202 is likely to cause harmful interference with the communication of the FS 301. The information collection server 402a transmits, to the control server 401, a stop request for stopping the transmission of the wireless signal from the STA 202 to the AP 201, similar to the information collection server 402 described with reference to FIG. 1.

Thus, the wireless control system 100a according to the present application example can stop the transmission of the STA 202 of the wireless LAN system 101 before the STA 202 enters the main beam 302 of the fixed wireless system 102 and causes harmful interference with the communication of the FS 301.

As in the above embodiment, when the STA 202 cannot stop the transmission of the wireless signal to the AP 201, the control server 401 may request the AP 201 to change the used frequency of the AP 201, so that the frequency of the wireless signal transmitted from the STA 202 to the AP 201 is changed. In this case, the frequency is changed to a frequency different from the frequency of FS 301.

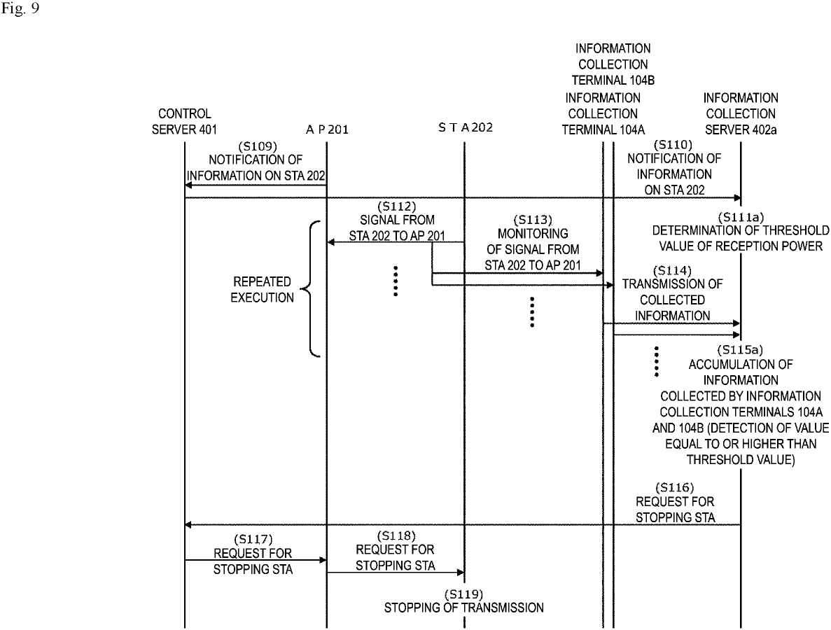

FIG. 9 illustrates an operation sequence of an application example. The operation sequence of FIG. 9 is an example in a case in which the two information collection terminals 104A and 104B described with reference to FIG. 8 are used. FIG. 9 corresponds to FIGS. 6 and 7 of the above embodiment. In FIG. 9, the information collection terminal 104A and the information collection terminal 104B monitor the wireless communication from the STA 202 to the AP 201 and collect the information on the wireless communication.

Here, in FIG. 9, description of processing having the same reference signs as those in FIGS. 6 and 7 will be omitted, and processing different from those in FIGS. 6 and 7 will be described. In FIG. 9, the processing different from those in FIGS. 6 and 7 are steps S111a and S115a.

In step S111a, the information collection server 402a derives a threshold value of reception powers for the two information collection terminals 104A and 104B detecting the approach of the STA 202 to the main beam 302 of the FS 301 from transmission power information on the STA 202. Here, it is assumed that the installation positions of the information collection terminal 104A and the information collection terminal 104B are set in the information collection server 402a in advance.

The operation from step S112 to step S115a is repeatedly executed until the reception powers of the information collection terminal 104A and the information collection terminal 104B satisfy Relationship (2) (or Relationships (1) and (2)) and thereby approach of the STA 202 to the communication area is detected.

When the approach of the STA 202 to the communication area is detected, the next step S116 is executed as in FIG. 7.

In step S116, the information collection server 402a transmits a stop request for stopping the transmission of the STA 202 to the control server 401.

Then, the processing from step S117 to step S119 are executed as in FIG. 7, and the transmission of the wireless signal from the STA 202 to the AP 201 is stopped.

Thus, the wireless control system 100a according to the present application example can detect the approach of the STA 202 to the main beam 302 with higher accuracy than in the wireless control system 100 by using the plurality of information collection terminals 104A and 104B. When the approach of the STA 202 to the main beam 302 is detected, the transmission of the STA 202 is stopped, so that harmful interference with the communication of the fixed wireless system 102 is avoided.

As described above, the wireless control method, the wireless control apparatus, and the wireless control system according to the present disclosure make it possible to detect that the movable wireless terminal of the first wireless system approaches the limited communication area of the second wireless system by using the information collection terminal. When the approach of the wireless terminal to the communication area is detected, the transmission of the wireless terminal is stopped. This prevents the movable wireless terminal of the first wireless system to which a method based on a use exclusion zone and a method of limiting the number of terminals are difficult to apply from entering the limited communication area of the second wireless system and causing harmful interference.

REFERENCE SIGNS LIST

| 100, 100a: | Wireless control system |
|---|---|
| 101, 101a: | Wireless LAN system |
| 102: | Fixed wireless system |
| 103, 103a: | Wireless control apparatus |
| 104, 104A, 104B: | Information collection terminal |
| 201: | AP |
| 202: | STA |
| 301: | FS |
| 302: | Main beam |
| 401: | Control server |
| 402, 402a: | Information collection server |
| 403: | FS-DB |
| 404: | AP-DB |
| 405: | Wireless environment DB |

1. A wireless control method comprising:
a first wireless system including a fixed wireless access apparatus configured to perform communication with at least one movable wireless terminal;
a second wireless system configured to perform communication in a limited communication area using a frequency band that is the same as or overlaps a frequency band of the first wireless system;
one or more information collection terminals configured to collect information on the wireless communication of the first wireless system, at least one of the one or more information collection terminals being installed in the communication area of the second wireless system; and
a wireless control apparatus configured to control the communication of the first wireless system, wherein
the wireless control apparatus controls the communication of the first wireless system such that communication of the wireless terminal does not cause harmful interference with the communication of the second wireless system, when approach of the wireless terminal to the communication area of the second wireless system is detected, based on information on the first wireless system and the second wireless system, and the information on the wireless communication collected by the one or more information collection terminals.

2. The wireless control method according to claim 1, wherein
the wireless control apparatus determines, based on information on a transmission power of the wireless terminal notified from the wireless access apparatus of the first wireless system, a threshold value of a reception power of a wireless signal at each information collection terminal, the wireless signal being transmitted by the wireless terminal, and
the wireless control apparatus detects approach of the wireless terminal to the communication area when the reception power of the wireless terminal collected by each information collection terminal is equal to or higher than the threshold value, and transmits a request for stopping the wireless terminal to the wireless access apparatus, and
the wireless access apparatus stops the wireless terminal or changes a frequency used by the wireless terminal when the wireless access apparatus receives the request for stopping the wireless terminal from the wireless control apparatus.

3. The wireless control method according to claim 2, wherein
the wireless control apparatus collects a first reception power of the wireless terminal collected by a first information collection terminal that is one of a plurality of the information collection terminals and is installed in the communication area of the second wireless system, and a second reception power of the wireless terminal collected by a second information collection terminal that is one of the plurality of the information collection terminals and is installed at a position away from the communication area, detects approach of the wireless terminal to the communication area when a difference between the first reception power and the second reception power is equal to or greater than a threshold value, and transmits a request for stopping the wireless terminal to the wireless access apparatus.

4. A wireless control apparatus configured to control communication of a first wireless system of a system, the system including the first wireless system including a fixed wireless access apparatus configured to perform communication with at least one movable wireless terminal, a second wireless system configured to perform communication in a limited communication area using a frequency band that is the same as or overlaps a frequency band of the first wireless system, and one or more information collection terminals configured to collect information on the wireless communication of the first wireless system, at least one of the one or more information collection terminals being installed in the communication area of the second wireless system, the wireless control apparatus comprising:
a database configured to store information on the first wireless system and the second wireless system, and the information on the wireless communication collected by the one or more information collection terminals;
an information collection server configured to determine, based on the information stored in the database and information on a transmission power of the wireless terminal notified from the wireless access apparatus of the first wireless system, a threshold value of a reception power of a wireless signal at each information collection terminal, the wireless signal being transmitted by the wireless terminal, detect approach of the wireless terminal to the communication area when the reception power of the wireless terminal collected by each information collection terminal is equal to or higher than the threshold value, and transmit a request for stopping the wireless terminal; and
a control server configured to determine a parameter of the wireless access apparatus based on the information stored in the database and transmit the request for stopping the wireless terminal received from the information collection server to the wireless access apparatus.

5. The wireless control apparatus according to claim 4, wherein the information collection server collects a first reception power of the wireless terminal collected by a first information collection terminal that is one of a plurality of the information collection terminals and is installed in the communication area of the second wireless system, and a second reception power of the wireless terminal collected by a second information collection terminal that is one of the plurality of the information collection terminals and is installed at a position away from the communication area, detects approach of the wireless terminal to the communication area when a difference between the first reception power and the second reception power is equal to or greater than a threshold value, and transmits a request for stopping the wireless terminal.

6. A wireless control system comprising:
a first wireless system including a fixed wireless access apparatus configured to perform communication with at least one movable wireless terminal;
a second wireless system configured to perform communication in a limited communication area using a frequency band that is the same as or overlaps a frequency band of the first wireless system;
one or more information collection terminals configured to collect information on the wireless communication of the first wireless system, at least one of the one or more information collection terminals being installed in the communication area of the second wireless system; and
a wireless control apparatus configured to control the communication of the first wireless system, wherein
the wireless control apparatus controls the communication of the first wireless system such that communication of the wireless terminal does not cause harmful interference with the communication of the second wireless system, when approach of the wireless terminal to the communication area of the second wireless system is detected, based on information on the first wireless system and the second wireless system, and the information on the wireless communication collected by the one or more information collection terminals.

7. The wireless control system according to claim 6, wherein
the wireless control apparatus determines, based on information on a transmission power of the wireless terminal notified from the wireless access apparatus of the first wireless system, a threshold value of a reception power of a wireless signal at each information collection terminal, the wireless signal being transmitted by the wireless terminal, and
the wireless control apparatus detects approach of the wireless terminal to the communication area when the reception power of the wireless terminal collected by each information collection terminal is equal to or higher than the threshold value, and transmits a request for stopping the wireless terminal to the wireless access apparatus, and
the wireless access apparatus stops the wireless terminal or changes a frequency used by the wireless terminal when the wireless access apparatus receives the request for stopping the wireless terminal from the wireless control apparatus.

8. The wireless control system according to claim 7, wherein
the wireless control apparatus collects a first reception power of the wireless terminal collected by a first information collection terminal that is one of a plurality of the information collection terminals and is installed in the communication area of the second wireless system, and a second reception power of the wireless terminal collected by a second information collection terminal that is one of the plurality of the information collection terminals and is installed at a position away from the communication area, detects approach of the wireless terminal to the communication area when a difference between the first reception power and the second reception power is equal to or greater than a threshold value, and transmits a request for stopping the wireless terminal to the wireless access apparatus.
